(19) United States
(12) Patent Application Publication
(10) Pub. No.: US 2026/0298696 A1
(43) Pub. Date: Oct. 1, 2026

(54) INTERMITTENT MOTION SCALE CONVEYOR

(71) Applicant: Mettler-Toledo, LLC, Columbus, OH (US)

(72) Inventors: Thomas Dorward, Lutz, FL (US); Jürgen Kress, Geisen (DE)

(21) Appl. No.: 19/477,990

(22) PCT Filed: May 9, 2023
(86) PCT No.: PCT/US2023/021506

§ 371 Date: Oct. 23, 2025

(51) Int. Cl. G01G 19/03; B07C 5/32; B07C 5/344; B07C 5/36

(52) U.S. Cl. CPC G01G 19/035; B07C 5/32; B07C 5/344; B07C 5/361

(57) ABSTRACT

A checkweighing operation device and system allows object acceptance or rejection based on at least a weight. A weighing platform determines the weight of the object placed thereon. A scale conveyor on the weighing platform has an endless loop of conveyor belt that passes across the weighing platform and is drivable in a first, or an opposing, second direction. A means for detecting the presence or absence of an object on the conveyor belt outputs a “presence” or “absence” signal. A controller receives the “presence” signal from the means for detecting, a weight signal proportional to the weight of the object from the weighing platform, and compares the weight signal to a predetermined range of acceptable weight. If within the predetermined range, the object is accepted by driving the conveyor belt in the first direction. Otherwise, the object is rejected by driving the conveyor belt in the second direction.

### TECHNICAL FIELD

A scale conveyor is used as an element of quality control, particularly in association with a machine that will place a package to be weighed onto the scale in a timed and consistent manner. If the package has an acceptable weight, a conveyor portion of the scale conveyor moves in a first direction, depositing the product onto a product conveyance system. If the package does not have an acceptable weight, the conveyor moves in a second direction, opposite the first direction, depositing the product into a reject system.

### BACKGROUND ART

A large variety of consumer products are packaged into a sealed pouch for sale. In some cases, the pouch is the final package; in other cases, the sealed pouch is placed into box or carton. The sealed pouch can accommodate liquids or dry goods, and can handle bulk packages as well as fine amounts, such as cosmetics.

The pouches are generally formed of a synthetic material, especially one that is capable of thermal welding. While usually a continuous web of the synthetic material is provided, the web can have perforations or, not nearly as commonly, an open mesh.

Pouch-filling machines as generally referred to as “FFS” machines, since the packaging system not only forms the pouch, but it also fills and seals the pouch. The pouch-filling machines are generally denoted as either “horizontal” and “vertical.” In a horizontal FFS machine, the web of the pouch-forming material is payed out horizontally, that is, with a longitudinal dimension of the web extending horizontally and a transverse dimension extending vertically. The vertical FFS machine pays out the web so that the longitudinal dimension is arranged vertically and the transverse dimension is arranged horizontally.

In a horizontal FFS machine, then, the payed-out web is formed into discrete pouches with side edges that are sealed, a closed bottom edge and an at least partially open top edge. A conveyor comprising spaced-apart gripping elements holds the pouches in a queue of products being made. After being formed, the individual pouches are filed and the top edges sealed as the pouches move along in a loop. At the end of the process, each product is released from the gripping elements and removed from the FFS machine.

The typical horizontal FFS machine operates very consistently and produces pouches that are within a predetermined tolerance for weight, resulting in very few pouches rejected for weight variance. However, the beginning and end of a run can cause problems, where a series of pouches may arrive at the scale conveyor out of the predetermined tolerance. Problems arising in the filling portion of the operation can also cause weight-based rejections.

Weighing of the individual pouches is viewed as accomplished best with a checkweigher that can be synchronized for receiving packages in a consistent, timed manner, regardless of the product, product size, manufacturer or model.

It is therefore an unmet need of the known prior art to provide a checkweigher that can interact physically and electronically at the end of a production queue having finished product to receive individual pouches of the product just as if the checkweigher was in the production queue, determine if each individual pouch is to be accepted or rejected, and to direct the individual pouches in an acceptance or a rejection direction.

### SUMMARY

These and other unmet needs of the prior art are met by a checkweighing operation device and a system incorporating such a device for “accept/reject” weighing of packaged objects.

The checkweighing operation device, as disclosed herein, comprises:
a weighing platform, for determining a weight of an object bearing upon the weighing platform and to output a weight signal proportional to the weight of the object;
a conveyor system, having a scale conveyor arranged on the weighing platform, comprising an endless loop of conveyor belt that passes over a top surface of the weighing platform, such that the endless loop of conveyor belt is arranged to be driven in a first direction or in a second direction that is opposite to the first direction;
a means for detecting the presence or absence of an object on the endless loop of conveyor belt, operative to output a “presence” or “absence” signal; and
a controller, in communication with each of: the weighing platform, the conveyor system, and the means for detecting the presence or absence, the controller being operative to:
   receive the “presence” signal from the means for detecting;
   receive the weight signal from the weighing platform;
   compare the weight signal to a predetermined range of acceptable weight; and
   if the weight signal is within the predetermined range, accept the object by causing the conveyor belt to be driven in the first direction sufficiently to remove the object from the scale conveyor;
   otherwise, reject the object by causing the conveyor belt to be driven in the second direction sufficiently to remove the object from the scale conveyor.

In some embodiments, the checkweighing operation device further comprises:
a first conveyor roller, arranged adjacent to a first side edge of the weighing platform;
a second conveyor roller, arranged adjacent to a second side edge of the weighing platform;
the controller is further operative to:
   accept the object by causing the conveyor belt to be driven in the first direction sufficiently to pass the object from the scale conveyor onto the first conveyor roller; and
   accept the object by causing the conveyor belt to be driven in the second direction sufficiently to pass the object from the scale conveyor onto the second conveyor roller; and
a means for selectively driving the endless loop of conveyor belt in the first direction and in the second direction, in communication with the controller.

In at least some of these checkweighing operation devices, the means for driving the endless loop of conveyor belt is a servo motor.

In some embodiments, the controller causes the endless loop of conveyor belt to constantly move in the first direction, unless and until the weighing platform output signal is outside of the predetermined range.

In some embodiments, the controller, upon receiving a “presence” signal, causes the endless loop of conveyor belt to remain static until the weight platform output signal is received.

In some embodiments, the controller causes the weight of the object, as determined from the weighing platform output signal, to be displayed on a weight display of the scale conveyor.

In some of these embodiments, if the weighing platform signal is within the predetermined range, the controller causes a signal consistent with acceptance of the object to be displayed on the weight display; but, otherwise, the controller causes a signal consistent with rejection of the object to be displayed on the weight display.

In some cehckweighing operation devices of the inventive concept, the object being accepted or rejected is placed vertically onto the weighing platform.

In a checkweighing operation system employing the inventive concept for “accept/reject” weighing of packaged objects, there is:
a production line having a plurality of the packaged objects, wherein one of the packaged objects is in a lead position, followed by a sequence of further packaged objects;
a scale conveyor; and
a means for transferring the packaged object in the lead position directly onto the scale conveyor;
wherein the controller (210) of the scale conveyor (214) is operative to:
   cause the means for transferring to place the packaged object in the lead position onto the scale conveyor;
   cause the production line to index forward, advancing a further packaged object into the lead position;
   weigh the packaged object on the scale conveyor and make an “accept/reject” determination on the packaged object; and
if the packaged object is “accepted”, cause the conveyor belt of the scale conveyor to move in the first direction, removing the packaged object onto a queue of accepted packaged objects,
otherwise, cause the conveyor belt to move in the second direction, removing the packaged object onto a queue of rejected packaged objects.

In one useful application of the checkweighing operation system, the production line is a horizontal in-line pouch filler.

In some of the systems, the means for transferring the packaged object is a pick-n-place arm.

In some of the systems, the means for transferring the packaged object is a chute positioned vertically above a feeder platform.

In some of the systems, the checkweighing operation system comprises a means for detecting a secondary product defect. In one such embodiment, this means for detecting a secondary product defect could be a metal detector to determine the presence of metallic contaminants.

### BRIEF DESCRIPTION OF THE DRAWINGS

The inventive concept will be better understood when reference is made to the appended drawings, in which identical parts are identified with identical part numbers and in which:

FIG. 1 is a schematic diagram of a production queue for forming, filling and sealing a packaged product, terminating in a checkweighing stage in which each unit of the packaged product is accepted or rejected; and

FIG. 2 is a schematic diagram showing the inventive concept as incorporated into the checkweighing stage.

### DETAILED DESCRIPTION OF THE EMBODIMENTS

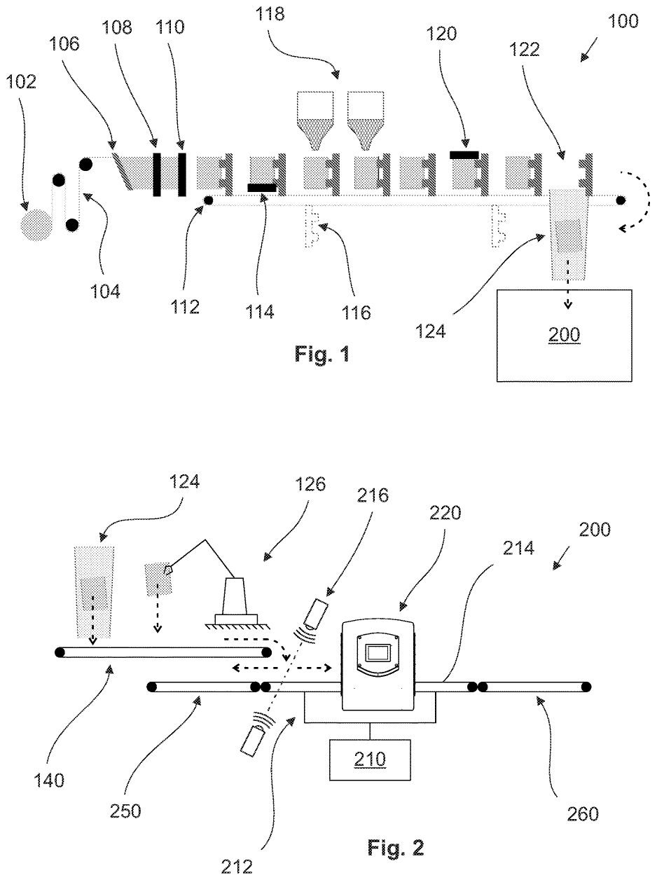

Turning first to FIG. 1, a schematic diagram depicts a production queue 100 as is generally known in the prior art, in which a package is formed, the formed package is filled with a product, and the formed and filled package exits from the production queue to a checkweighing operation stage 200 that is proximate to the production queue. Specific details of the checkweighing operation stage 200 are presented in more detail in FIG. 2.

Activity in the production queue 100 moves generally from the right to the left. A web or roll 102 of a film, usually a polymeric film, is arranged to pay out the film, and is shown with a series 104 of rollers for providing and maintaining a tension on the film. It is particularly desirable to use a web or roll 102 in which the film being payed out in a two-ply form, so that at least one side edge of the package to be formed is already in place. An especially useful way to do this, as is depicted in the subsequent handling equipment, is to have the web or roll 102 comprise a pre-formed tube in which each side edge of the package is already formed. Such a web 102 may be prepared from an extrusion process, for example.

In a package forming operation, depicted at reference numbers 106-110, the package is formed from the web or roll 102. Specific operations shown in FIG. 1 include a forming plow 106, a pair of side edge jaws 108 that grasp the incipient package by the side edges, and a cutoff knife 110 that separates the incipient package from the web 102. It should be noted that FIG. 1 shows the package forming operation as an integral portion of the production queue 100, but, in fact, the production queue could operate effectively with a supply of empty packages that were formed remotely and are only incorporated into the queue as needed.

Once formed, the open-top package is introduced into an intermittent conveyor 112 that moves in discrete, indexed, steps rather than continuous flow. As shown at 116, the package carriers circulate beneath a carrier chain of the conveyor 112 after transporting a package through the process. Reference numbers 114-122 constitute the filling and sealing steps, but can be broken down further into receiving and sealing the bottom edge of the package at 114, filling the open-top package at 118, final sealing of the top edge of the package at 120 and discharge of the package at 122. Notably, the filling step is depicted as occurring in two steps, the first of which may be a gross filling step and the second a more finely-tunable step, as may be implemented by feedback from the checkweighing process 200. However, the use of more than one filling step is entirely optional, as is the use of more than two filling steps.

FIGS. 1 and 2 each show a chute 124 as a means for allowing gravity to deposit a finished package into the checkweighing operation stage 200, where the primary focus of the inventive concept is encountered. This checkweighing operation stage 200 and its elements are shown schematically in FIG. 1, but are detailed in an exemplary embodiment in FIG. 2. In a first variation of such an embodiment, the package is received on a feeder platform 140. In the first variation, the feeder platform 140 is an intermittent conveyor that can be operated selectively to move the package onto a scale conveyor 214 associated directly with the weighing platform 212. In the second variation, also depicted, a robot 126 is positioned for selectively picking up the package from the discharging gripper 116 of the production queue and placing it on conveyor 214 upstream of the weighing platform 212. In either of the variations, a sensor system 216 is schematically depicted in the path between platform 140, or the robot 126 respectively, and conveyor 214, so that movement of a package through a sensor beam signals the presence of a package to be weighted on the conveyor 214. An alternate sensing means could involve a pressure sensor associated with the scale conveyor 214. In any case, the presence of the package in the upstream portion of the scale conveyor 214 triggers a controller 210 for bi-directional operation of the scale conveyor 214, so that the package is distinctively moved on the weighing platform 212. With only an individual package on conveyor 214, the weighing platform 212 weighs the package and compares the measured weight against a predetermined weight tolerance range. If the weight is within the range, the controller 210 causing the scale conveyor 214 to move the accepted package in a first direction (to the right in the depicted embodiment), where it is moved onto a further conveyor 260. In some embodiments, conveyor 260 may be optional and the package may simply drop into a zone for receiving accepted packages.

On the other hand, if the package being weighed is outside of the predetermined tolerance range, either high or low, the package becomes a rejected package and mechanism 210 is actuated to move the rejected package in a second direction (to the left in the depicted embodiment), where it is moved onto a further conveyor 250. In some embodiments, conveyor 250 may be optional and the package may simply drop into a zone for receiving rejected packages.

Except for start-up or shut-down periods, the huge majority of packages moving through the checkweighing operation stage 200 should exit the stage to the right. When this is occurring, the rightward movement of the conveyor 214 may be used to stage the next package in the queue into position for weighing.

Optionally, the package with a weight signal that is within the predetermined range can further be inspected by a means for detecting a secondary product defect, that is, a product defect other than weight. One such means for detecting would be a metal detector 220 for determining if the package contains unwanted contaminants. If the metal detector output signal represents an uncontaminated package, the controller 210 causes the scale conveyor 214 to move the accepted package further in the first direction (to the right in the depicted embodiment), where it is moved onto a further conveyor 260. If the metal detector output signal represents a contaminated package, the controller 210 causes the scale conveyor 214 to move the accepted package in the second direction (to the left in the depicted embodiment), where it is moved onto the conveyor 250. In some further embodiments, the metal detector output signal may be used to segregate the contaminated packages after moving further in the first direction by a sorting device known to the prior art like a flap sorter or a pusher.

Exemplary embodiments of the inventive concept comprise a scale conveyor having a conveyor system with a scale conveyor 214, a weighing platform 212 that underlies the conveyor system, and a controller 210 that operates the conveyor system based upon input from the weighing platform.

When the weight of an individual object received on the scale conveyor 214 is determined by the weighing platform 212 to be within a predetermined tolerance of a target weight, the scale conveyor 214 of the conveyor system is driven sufficiently in a first direction to remove the object from the scale conveyor 214 onto an “accepted” queue of objects. When the weight of the individual object received on the scale conveyor 214 is determined by the weighing platform 212 to be outside of the predetermined tolerance of the target weight, the belt is driven sufficiently in a second direction to remove the object from the scale conveyor 214 onto an “rejected” queue of objects. Objects that are rejected for having a weight that is outside of tolerance, whether high or low, are assigned to the same “rejected” queue.

The scale conveyor, by its nature, weighs products on an individual basis. If two products are weighed simultaneously, a cumulative variance of two products having acceptable weights could result in an apparently unacceptable variation. Likewise, a simultaneous weighing of two products, each of which has an unacceptable variance, could result in an average weight that would appear to be acceptable.

These requirements of the system place limitations on the operation of the scale conveyor. The controller 210 needs a means for detecting the presence or absence of an object on the scale conveyor belt, operative to output a “presence” or “absence” signal. This may, in some instances, be a visual means for detecting objects. In other instances, the means can be the weight signal being generated by the weighing platform 212, and it clearly can be a combination of visual and weight. In any case, the “presence” or “absence” signal generated by the controller 210 should be communicated to the production queue 100 providing objects to be weighed, to synchronize the operations.

The conveyor of the conveyor system may be an endless loop of conveyor belt that passes across a top surface of the weighing platform and under the weighing platform. A drive means should be arranged to drive the endless loop belt in either a first direction or in a second direction that is opposite to the first direction, so that a product may be removed in either direction from the scale conveyor, without a need to reverse the belt to an original condition after the product is removed.

When the scale conveyor uses the endless loop of conveyor belt, a first conveyor roller may be arranged adjacent to a first side edge of the weighing platform 212, to receive the endless loop and a second conveyor roller may be arranged on a second side edge of the weighing platform, also to receive the endless loop. The drive means may be positioned at a lower portion of the scale base. Tensioning rollers may be used to provide purchase between the drive means and the belt. The drive means may be a roller that is driven by a servo motor, or the like, under the control of the controller.

In another possible embodiment a length of belt can be moved between a pair of rollers, one of which is on each side of the scale conveyor to achieve the same object. In such a case, each of the rollers, rather than being free-spinning, needs to be drivable, such as by a servo motor, so that the length of belt is pulled toward, and rolled up on, a driven roller while be payed out from the other roller, which is, at least in this situation, free-spinning. This complicates the drive system, as it may require multiple servo motors and a clutch to engage or disengage the roller from the motor. A preference may be for the endless loop when the production process is expected to operate at long continual sequences of acceptances or rejections, as the endless loop belt will tend to rotate in the first direction or the second, without having to be returned.

In either type of belt arrangement, the belt should not be moving while a weight measurement is being taken, but it should be quickly activated and moved in the correct direction once an “accept” or “reject” determination is made. With the endless loop system, the belt does not need to be returned to an initial position, but when the length of belt case is driven by two rollers, a return of the belt will need to be made.

In many of the embodiments, it may be desirable to provide a visual means, associated with the controller, for displaying the measured weight, with the possible display of the target weight and/or the variance between the target weight and the measured weight. In some instances, it may be at least as desirable to use color signals, such as a green light for an “acceptance” and a red light for a “rejection” to provide quick verification of the production operation from across the plant floor.

The controller, as noted, will manage operation of the scale conveyor. It achieves this by noting the presence of an object to be weighed on the weighing platform, receiving from the weight platform a signal based on the measured weight of the object, comparing the measured weight signal to a predetermined target weight, and determining if the object is to be accepted or rejected. The conveyor belt is moved in one direction or the other to move an accepted object forward for processing or removing a rejected object out of the production queue. Once the weighed object is removed from the weighing platform, the production line that provides the objects can be signalled to place another object on the scale conveyor to continue the process.

Preferably, the controller provides measured weight data to a display means and also logs measured weight data, either on internal memory or by sending the data to an external database. In either case, the physical location of the scale conveyor at a terminus of the production line, as well as the data generated, present an ideal opportunity for quality control.

While the controller may be located in or proximate to the scale conveyor, the control may be accomplished by integration into a process control computer for the production line.

It may be preferred to have the object being weighed to be placed on the weighing platform in an orientation that minimizes the “footprint” of the object on the belt, as this may facilitate removal of the object from the belt at the appropriate side edge of the weighing platform.

Other aspects of the inventive concept may be achieved by a system for “accept/reject” weighing of packaged objects. Such a system would comprise a production line capable of moving a plurality of the packaged objects to a scale conveyor as described above. The production line could include the actual filling of a package, resulting in the packaged objects, or it could be a production line in which the packaged objects are already packaged before being added to the production line. In either case, it may be preferred to arrange the production line in a closed loop to result in the sequence of spaced-apart packaged objects moving from a position at which the packaged objects are acquired to a terminal position at which the packaged objects are deposed from the production line to be tested as to weight. This production line may move in a continuous manner, but is more likely to move intermittently from one indexed position to the next, and ultimately to the terminal position. Proximate to the terminal position is a scale conveyor of the type described above. Preferably, at least the terminal position of the production line is located higher than the scale conveyor, so that gravity can be used in moving the packaged objects from the terminal position onto the scale conveyor. It may be preferred for the packaged objects to pend downwardly from a grasping means of the production line.

In one variation of the system, a controller for the production line advances one of the packaged objects into the terminal position, at which point the production line preferably stops. Upon a signal of the scale conveyor, the controller causes the grasping means to release the packaged object in the terminal position. Preferably, a means for facilitating transfer to the scale conveyor is used to move the packaged object to a weighing position on scale conveyor. The means for transferring may be a passive means, such as a chute, but it also may be an active means, such as a “pick and place” arm. Upon releasing the packaged object at the terminal position, the controller causes the production line to move forward, advancing the next packaged object in the sequence into the terminal position.

At this point, the scale conveyor weighs the packaged object on the scale conveyor and makes an “accept/reject” determination. If the packaged object is “accepted,” the conveyor belt of the scale conveyor moves in the first direction, removing the packaged object onto a queue of accepted packaged objects. Otherwise, the conveyor belt moves in the second direction, removing the packaged object onto a queue of rejected packaged objects.

In some embodiments of the system, the production line is a horizontal in-line pouch filler. In such systems, the use of the checkweighing operation stage 200 is useful not only in providing necessary quality control, but also in providing feedback on the operation of the production line, especially with regard to the filing operation 118.

1. A checkweighing operation device for accepting or rejecting an object based on weight, comprising:
a weighing platform, for determining a weight of an object bearing upon the weighing platform and to output a weight signal proportional to the weight of the object;
a conveyor system, having a scale conveyor arranged on the weighing platform, comprising an endless loop of conveyor belt that passes over a top surface of the weighing platform, such that the endless loop of conveyor belt is arranged to be driven in a first direction or in a second direction that is opposite to the first direction;
a means for detecting the presence or absence of an object on the endless loop of conveyor belt, operative to output a “presence” or “absence” signal; and
a controller, in communication with each of: the weighing platform, the conveyor system, and the means for detecting the presence or absence, the controller operative to:
receive the “presence” signal from the means for detecting;
receive the weight signal from the weighing platform;
compare the weight signal to a predetermined range of acceptable weight; and
if the weight signal is within the predetermined range, accept the object by causing the conveyor belt to be driven in the first direction sufficiently to remove the object from the scale conveyor;
otherwise, reject the object by causing the conveyor belt to be driven in the second direction sufficiently to remove the object from the scale conveyor.

2. The checkweighing operation device of claim 1, wherein:
the conveyor system further comprises:
a first conveyor roller, arranged adjacent to a first side edge of the weighing platform;
a second conveyor roller, arranged adjacent to a second side edge of the weighing platform;
the controller is further operative to:
accept the object by causing the conveyor belt to be driven in the first direction sufficiently to pass the object from the scale conveyor onto the first conveyor roller;
accept the object by causing the conveyor belt to be driven in the second direction sufficiently to pass the object from the scale conveyor onto the second conveyor roller; and
a means for selectively driving the endless loop of conveyor belt in the first direction and in the second direction, in communication with the controller.

3. The scale conveyor of claim 2, wherein the means for driving the endless loop of conveyor belt is a servo motor.

4. The scale conveyor of claim 2, wherein the controller causes the endless loop of conveyor belt to constantly move in the first direction, unless and until the weighing platform output signal is outside of the predetermined range.

5. The scale conveyor of claim 2, wherein the controller, upon receiving a “presence” signal, causes the endless loop of conveyor belt to remain static until the weight platform output signal is received.

6. The scale conveyor of claim 1, wherein the controller causes the weight of the object, as determined from the weighing platform output signal, to be displayed on a weight display of the scale conveyor.

7. The scale conveyor of claim 6, wherein:
if the weighing platform signal is within the predetermined range, the controller causes a signal consistent with acceptance of the object to be displayed on the weight display;
otherwise, the controller causes a signal consistent with rejection of the object to be displayed on the weight display.

8. The scale conveyor of claim 1, wherein the object being accepted or rejected is placed vertically onto the weighing platform.

9. A system for “accept/reject” weighing of packaged objects, comprising:
a production line having a plurality of the packaged objects, wherein one of the packaged objects is in a lead position, followed by a sequence of further packaged objects;
a scale conveyor according to claim 1; and
means for transferring the packaged object in the lead position directly onto the scale conveyor;
wherein the controller of the scale conveyor is operative to:
cause the means for transferring to place the packaged object in the lead position onto the scale conveyor;
cause the production line to index forward, advancing a further packaged object into the lead position;
weigh the packaged object on the scale conveyor and make an “accept/reject” determination on the packaged object; and
if the packaged object is “accepted”, cause the conveyor belt of the scale conveyor to move in the first direction, removing the packaged object onto a queue of accepted packaged objects,
otherwise, cause the conveyor belt to move in the second direction, removing the packaged object onto a queue of rejected packaged objects.

10. The system of claim 9, wherein:
the production line is a horizontal in-line pouch filler.

11. The system of claim 9, wherein the means for transferring the packaged object is a pick-n-place arm.

12. The system of claim 9 , wherein the means for transferring the packaged object is a chute positioned vertically above a feeder platform.

13. The system of claim 9, further comprising a means for detecting a secondary product defect.

14. The system of claim 13, wherein the means for detecting a secondary product defect is a metal detector to determine the presence of metallic contaminants.
